(19) United States
(12) Patent Application Publication
(10) Pub. No.: US 2005/0187047 A1
(43) Pub. Date: Aug. 25, 2005

(54) CVT transmission with offset axes for tractor

(76) Inventor: Giancarlo Benassi, Modena (IT)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/037,271

(22) Filed: Jan. 18, 2005

(30) Foreign Application Priority Data
Jan. 16, 2004 (IT) BO2004A000017

(51) Int. Cl. F16H 61/00; F16H 63/00

(52) U.S. Cl. 474/23

(57) ABSTRACT

A tractor includes an engine and a transmission drivingly coupled to the engine. The transmission has a longitudinal dimension and includes at least two pulleys and an epicyclic rotary mechanism including a sun gear with an axis of rotation, the pulleys each having an axis of rotation. The axes of rotation of the pair of pulleys and the sun gear form a triangle in a plane perpendicular to the longitudinal dimension of the transmission.

### BACKGROUND OF THE INVENTION

1. Field of the Invention

The present invention relates to a CVT transmission for motor vehicles, in particular for farm tractors.

2. Technical Background

In the field of tractors, transmissions in which a continuous control of speed is effected, called CVT transmissions, are known. In other words, in these transmissions, one is able continuously to regulate the speed of the motor vehicle, throughout the range between the maximum forward speed and the maximum reverse speed.

In particular, in known solutions, the CVT transmission comprises an apparatus for the continuous variation of the motion in terms of delivered torque and speed. Such a transmission is known, for example, from the patent EP-B1-0 889 260.

However, EP-B1-0 889 260 has a disadvantage of not being optimally compact and therefore is not suitable for use in low-power tractors in which the volume of the components constitutes a determining factor. For example, the epicyclic rotary mechanism is positioned at the central axis of one of the two expandable pulleys. This entails larger transverse dimensions than are optimal in the field of low-power tractors.

An object of the present invention, therefore, is to provide a CVT transmission for motor vehicles, in particular for low-power farm tractors, that permits an optimal placement of transmission components.

### SUMMARY OF THE INVENTION

According to an aspect of the invention, a tractor includes an engine and a transmission drivingly coupled to the engine. The transmission has a longitudinal dimension greater and includes at least two pulleys and an epicyclic rotary mechanism including a sun gear with an axis of rotation, the pulleys each having an axis of rotation. The axes of rotation of the pair of pulleys and the sun gear form a triangle in a plane perpendicular to the longitudinal dimension of the transmission.

According to another aspect of the invention, a tractor includes an engine, a drive shaft driven by the engine, and transmission means for continuously varying drive ratios. The transmission means includes at least two pulleys and an epicyclic rotary mechanism including a sun gear with an axis of rotation, at least one primary pulley being selectively driven by the engine and at least one other pulley being driven by the primary pulley. Each pulley has an axis of rotation. The axis of the drive shaft, the pulleys and the sun gear are offset.

### BRIEF DESCRIPTION OF THE DRAWINGS

The present invention will now be described further, with reference to the accompanying drawings, which show a non-limiting example, in which:

FIG. 1 schematically shows a plan view of a CVT transmission for motor vehicles, in particular for farm tractors, according to a preferred embodiment of the present invention; and

FIG. 2 shows a front view of the transmission of FIG. 1, the outer profile of the engine being shown in dashed lines.

### DETAILED DESCRIPTION OF THE PREFERRED EMBODIMENT

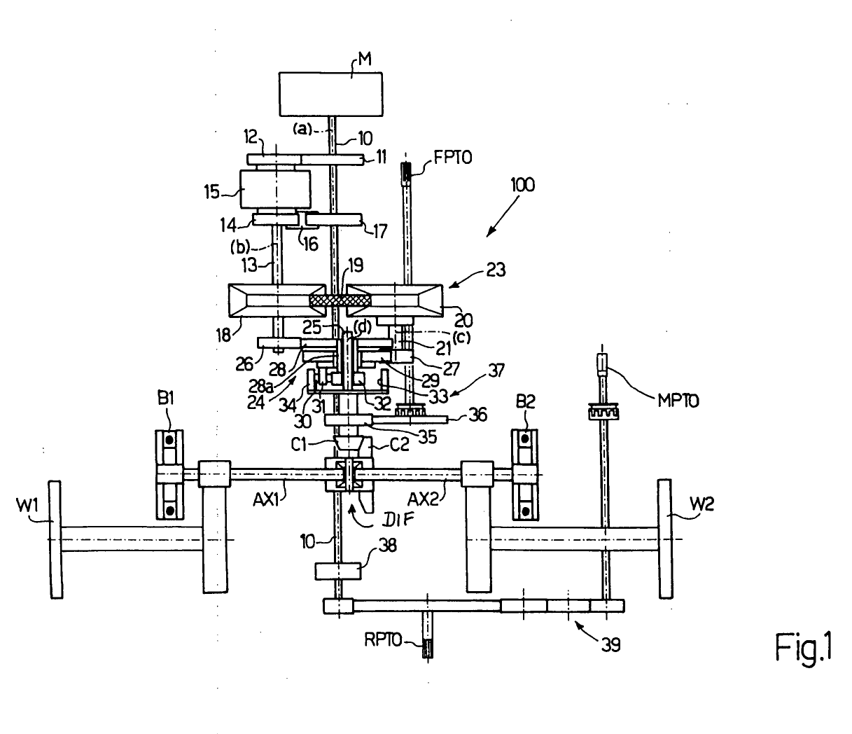

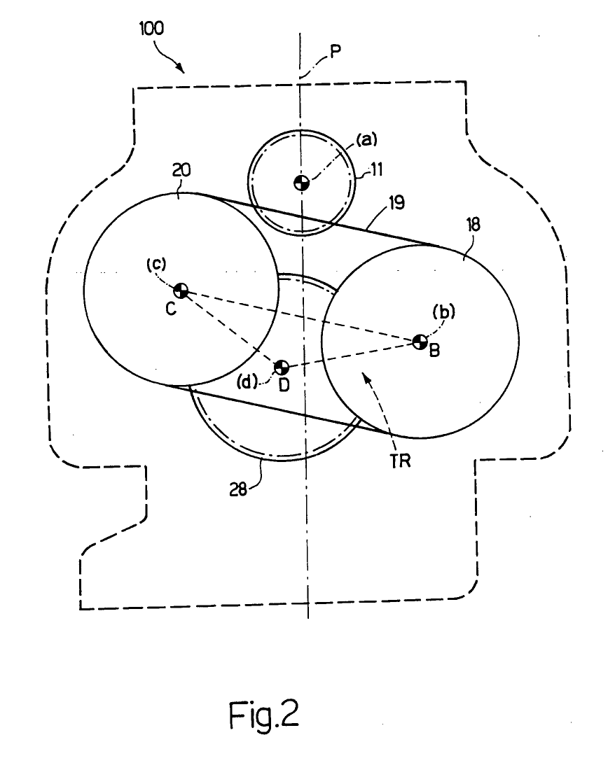

In a transmission 100 shown in FIGS. 1 and 2, the mechanical power produced by an engine M of, e.g., a tractor is transmitted to a first shaft 10, which represents the drive shaft and sets in rotation the wheels W1 and W2 and preferably a rear power take off, RPTO (see below).

As shown in FIG. 2, the axis (a) of the drive shaft 10 lies on a plane of substantial transverse symmetry of the tractor engine. The drive shaft 10 is substantially transversely centered in the outline (shown in FIG. 2 in broken lines) of the engine.

As shown in FIGS. 1 and 2, on the drive shaft 10 is keyed to a gear wheel 11 meshed with another idle gear wheel 12 on a shaft 13 (having an axis (b)) parallel to the drive shaft 10 itself (with axis (a)). Moreover, on the shaft 13 is idle another gear wheel 14. The shaft 13 also bears a clutch 15 which, for purpose that will become more readily apparent below, is able to make integral with the shaft 13 either the gear wheel 12 or the gear wheel 14. The gear wheel 14, in turn, through an idle gear wheel 16 meshes with a gear wheel 17, also keyed on the aforementioned drive shaft 10.

If the gear wheel 12 is made to rotate with the shaft 13 by the clutch 15 (and, consequently, the gear wheel 14 on the shaft 13 is made idle), motion is transmitted by the drive shaft 10 to the shaft 13 in “direct” fashion. In other words, the motor vehicle will travel “in forward running mode.” On the other hand, if the gear wheel 14 is made to rotate with the shaft 13 (and consequently, the gear wheel 12 on the shaft 13 is made idle) then motion is transmitted by the drive shaft 10 to the shaft 13 in “reverse” fashion. In other words, the tractor will travel “in reverse running mode” owing to the presence of the idle gear wheel 16.

On the shaft 13 is also keyed an expandable pulley 18, coupled by means of belt (or chain) 19 to a second pulley 20, also expandable, keyed onto a shaft 21 (having an axis (c)). The set of pulleys 18, 20, with the respective shafts 13, 21, and the belt (or chain) 19 constitutes a device 23 for the continuous variation of motion.

As shall be seen, both shafts 13 and 21 are kinematically united to an epicyclic rotary mechanism 24 having a central shaft 25, whose axis (d) is parallel to the aforesaid axes (a), (b), and (c). For this purpose, on the shaft 13 is keyed a gear wheel 26, whilst a gear wheel 27 is integral with the shaft 21. The gear wheel 26 meshes with the sun gear 28 of the epicyclic rotary mechanism 24 (the sun gear 28 is idle on the central shaft 25) whilst the wheel 27 transmits motion to a spider 29 mounted idle on a coupling box 28a of the aforesaid sun gear 28. In a manner known in itself, to the spider 29 is associated with a plurality of satellites 30 (only one is shown in FIG. 1), each of which is pivotally engaged to a respective pivot pin 31 in a single piece with the spider 29.

As shown in FIG. 1, each planet gear 30 meshes at one side with a gear wheel 32 formed into a single piece with the sun gear 28, and on the other side with an inner toothing 33 of the crown 34 integral with the central shaft 25.

In known fashion, at the epicyclic rotary mechanism 24 the algebraic sum occurs of the motions coming, respectively, from the coupling of the gear wheel 26 with the sun gear 28 (with constant transmission ratio), and from the coupling of the gear wheel 27 with the spider 29 (variable transmission ratio achieved by means of the continuous motion variation device 23). By exploiting the combinatory effects of the two motions which occur at the epicyclic rotary mechanism 24 it is possible to obtain the desired continuous speed variation to change in the desired fashion the rotation speed of a bevel pinion C1 meshed with a ring bevel gear C2 belonging to a differential gear DIF.

As is well known, by changing the angular speed of the ring bevel gear C2 over time it is possible to change over time also the speed of the differential gear DIF and hence of the pair of rear wheels W1, W2 joined thereto by means of two axles AX1, AX2 supported, respectively, by a bearing B1 and a bearing B2.

Observing FIGS. 1 and 2 together, it is readily apparent that the axis (d) of the central shaft 25 of the epicyclic rotary mechanism 24 and the axes (b) and (c) of the pulley 18 and the pulley 20 are positioned according to vertices DBC of a triangle TR.

This physical characteristic translates into a considerable improvement in terms of the compactness of the transmission 100 and in a close proximity of its transverse dimensions with respect to the trace P (FIG. 2). Moreover, the central placement both of the drive shaft 10 and of the triangle TR has the additional advantage that the disposition of the different PTOs (power take offs) of the tractor is particularly convenient.

It should also be noted that the triangle TR is positioned in substantially balanced fashion relative to the trace P, and the trace P passes at a small distance from the axis (d) of the central shaft 25 of the epicyclic rotary mechanism 24.

All this has the consequence of an equilibrium between the transmission members, and an optimal disposition of the parts, to reduce, as much as possible, the transverse dimensions (for example relative to the axis (a) of the transmission shaft 10).

Moreover, if the central shaft 25 comprises an additional gear wheel 35 downstream of the epicyclic rotary mechanism 24, the gear wheel can be made to mesh with a gear wheel 36 associated with a motion transmission device 37 and a front PTO, FPTO for actuating a pair of front wheels (not shown), a device that will be inserted (with known means) if the tractor is to travel using all four drive wheels.

Advantageously, the transmission system 100 of the present invention, in addition to the aforesaid FTPO and RPTO (which may be connectable/detachable to/from the shaft 10 by means of a clutch 38), can provide for the use of an additional PTO located in intermediate position relative to the first two and designated herein as MPTO.

The MPTO takes motion from the RPTO by means of a gear train 39 and it serves the purpose of actuating, at the operator's choice, a series of tools (not shown herein) which are positioned in the lower part of the tractor.

1. A tractor comprising:
an engine; and
a transmission drivingly coupled to the engine, the transmission having a longitudinal dimension and including at least two pulleys and an epicyclic rotary mechanism including a sun gear with an axis of rotation, each pulley having an axis of rotation,
wherein the axes of rotation of the at least two pulleys and the sun gear form a triangle in a plane perpendicular to the longitudinal dimension of the transmission.

2. A tractor comprising:
an engine;
a drive shaft driven by the engine;
transmission means for continuously varying drive ratios, the transmission means including at least two pulleys and an epicyclic rotary mechanism including a sun gear with an axis of rotation, the at least two pulleys each having an axis of rotation, at least one primary pulley being selectively driven by the engine and at least one other pulley being driven by the primary pulley,
wherein the axis of the drive shaft, the pulleys and the sun gear are offset.

3. A tractor according to claim 2, further comprising a differential drivingly coupled to the epicyclic rotary mechanism, axles driven by the differential, bearings supporting the axles, and at least one of a rear power take off, a front power take off and a middle power take off, the at least one rear power take off, front power take off and middle power take off driven by the drive shaft.

4. A tractor according to claim 3, further comprising means for driving the at least one of the rear power take off, front power take off and middle power take off
